(19) United States
(12) Patent Application Publication
(10) Pub. No.: US 2010/0194896 A1
(43) Pub. Date: Aug. 5, 2010

(54) AUTOMATICALLY TAGGING IMAGES WITH NEARBY SHORT RANGE COMMUNICATION DEVICE INFORMATION

(75) Inventor: Scott Heimendinger, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/365,817

(22) Filed: Feb. 4, 2009

(51) Int. Cl. H04N 5/225

(52) U.S. Cl. 348/207.1; 348/E05.024

(57) ABSTRACT

Digital cameras are enabled to tag pictures with short range transmitter information from nearby devices. After uploading to a personal computer, a photo application further tags a user profile identifier matching the short range transmitter information. Tagged pictures are stored in a server for presentation. Any user with nearby device identifier or the nearby device itself can authenticate themselves to the server for automated access to tagged pictures.

### BACKGROUND

While the increasing use of the world wide web provides many avenues for groups to upload and exchange digital pictures doing so is still a multi-step, often cumbersome process. Web services that host pictures typically require manual authentication and extensive browsing just to gain access to pictures of interest. Picture takers also need to manipulate permissions settings to manage picture access.

Another recent development in electronics industry and use of electronic devices by consumers is the proliferation of wireless communication devices. Short range communication devices in particular are increasingly found in many aspects of daily life. Smaller and relatively low-powered transceivers are integrated into a wide variety of devices to enable the automatic exchange of information, and to simplify many processes such as user authentication, contact information exchange between mobile devices, and other similar scenarios.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to associating captured images with nearby device information in order to facilitate identification of people in the captured image or in the vicinity to the captured images, and facilitate subsequent access to the captured image for those people. Image capturing devices according to embodiments are enabled to detect nearby devices with short range transmitters and use identifiers of such devices to store that information in association with captures image data. Captured images may then be made available through direct access following the capture of the image or through a networked image download service.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating an example digital camera;

FIG. 2A illustrates an example scenario, where a digital camera records short range transceiver identifier containing device information of nearby devices during image capture for automating subsequent access to the image;

FIG. 2B illustrates another example scenario, where the digital camera notifies nearby devices of the recording of the short range transceiver identifier during image capture;

FIG. 3 illustrates a logic flow diagram for an example process of taking a picture and adding short range transceiver identifier to metadata of the picture;

FIG. 4 illustrates identifier information in a short range transmitter tag to be stored in picture captured image;

FIG. 5 illustrates another logic flow diagram for determining device tags in a captured picture and matching to a user profile to add user profile identifier to the metadata of the picture;

FIG. 6 is a networked environment, where a system according to embodiments may be implemented; and

FIG. 7 is a block diagram of an example digital camera environment, where an image processing application according to embodiments may be implemented.

### DETAILED DESCRIPTION

As briefly described above, nearby device identifier information may be detected and recorded during image capture by a digital camera for access to the captured image by owners of the detected nearby devices. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on a firmware on a digital camera or on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media. The computer program product may also be a propagated signal on a carrier (e.g. a frequency or phase modulated signal) or medium readable by a computing system and encoding a computer program of instructions for executing a computer process.

Throughout this specification, the term “platform” may be a combination of software and hardware components for managing access to captured images such as pictures, video, etc. Examples of platforms include, but are not limited to, a hosted service executed over a plurality of servers, an application executed on a single server, and comparable systems. The term “server” refers to a computing device executing one or more software programs typically in a networked environment. More detail on these technologies and example operations is provided below.

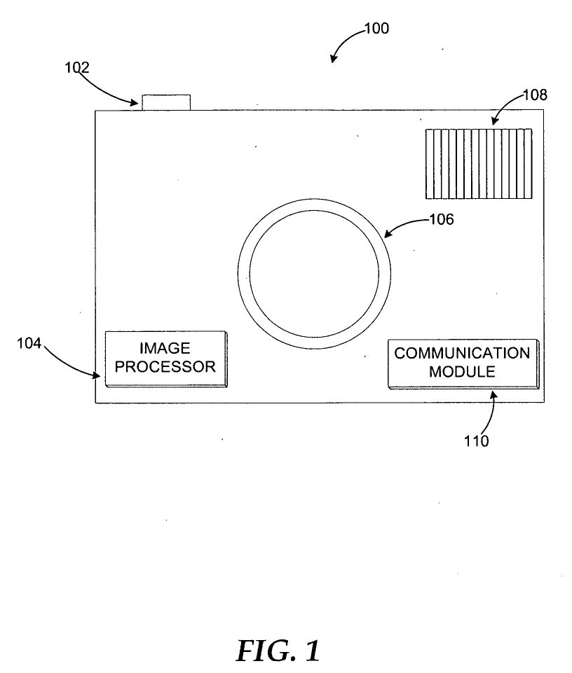

Referring to FIG. 1, diagram 100 of an example digital camera is illustrated. A digital camera is an image capturing device that converts captured images into digital information that is stored for later access. Stored images may be displayed on the camera or transmitted to other media for printing, display and editing.

In a digital camera such as the one shown in diagram 100, a user may capture a still image by pressing a button 102. Flash 108 may be engaged to illuminate the objects to be captured in the still image. Camera lens 108 may have a shutter that opens and closes to allow light to enter camera's picture capture components. Image processor 104 may process captured images and manage their storage. Communication module 110 may handle communication with other computing devices for uploading/storage of captures images, receiving configuration instructions, and with nearby devices using a short range transmitter to associate captured images with identifiers of the nearby devices.

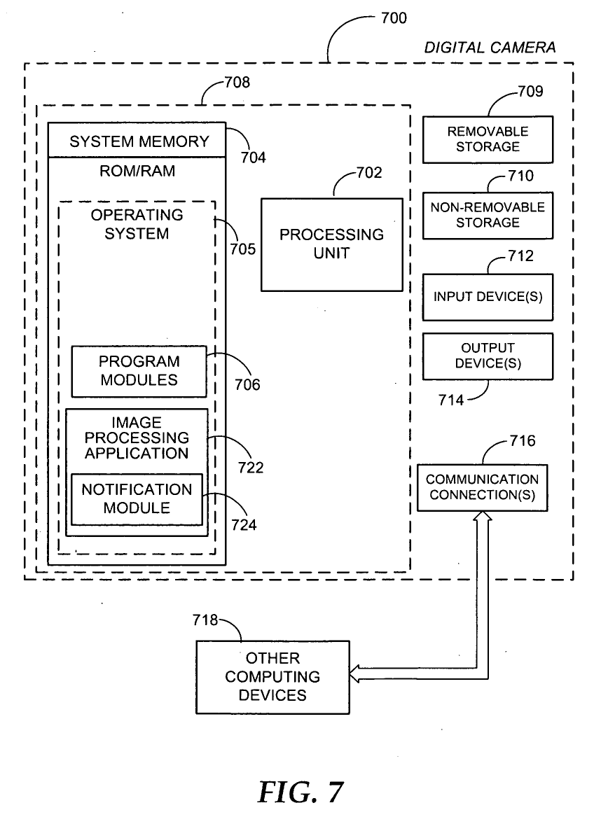

As discussed in more detail below in conjunction with FIG. 7, communication module 110 may facilitate wired or wireless communications using a number of standard or custom protocols. For example, commonly used short range wireless communication protocols such as Bluetooth® or Universal Serial Bus (USB) Human Interface Device (HID) may be employed to communicate with other devices.

When images are captured, users may upload the images to portable storage devices, other computing devices, or networked systems such as a web access service. The images may then be made available to others, such as the people in the captured images, by physical transfer (e.g. on a portable storage device), electronic mail or other communication means, or by enabling others to download the images from a computing device or networked system. However, that typically involves user intervention in form of determining who should receive the images, uploading the images, setting access privileges, and comparable actions.

In a system according to embodiments, determination of who should have access to the captured images and providing the pictures steps may be automated through associating the captured images with identifier information from nearby devices with short range transmitters. For example, a digital camera according to embodiments may determine nearby devices (e.g. cellular phones) with Bluetooth transceivers and record their identifiers along with captured images. Later, the pictures may be stored such that owners of the determined devices can have access to the captured images. The captured images may include still images or video images. However, embodiments are not limited to these, even audio recordings may be employed for a system according to embodiments. The identifier information may be associated with the recorded image by employing a database, inserting data (e.g. a tag) into the image file, or other methods.

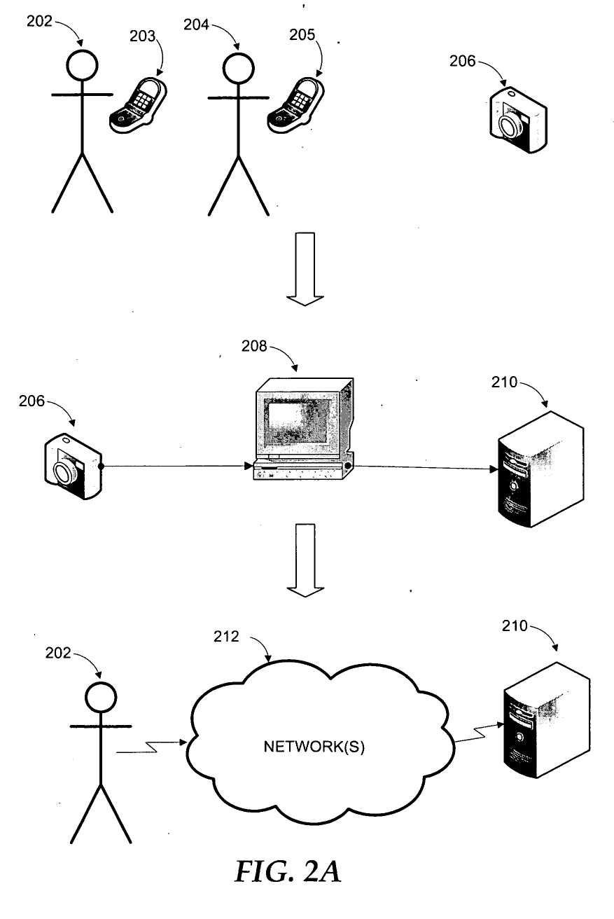

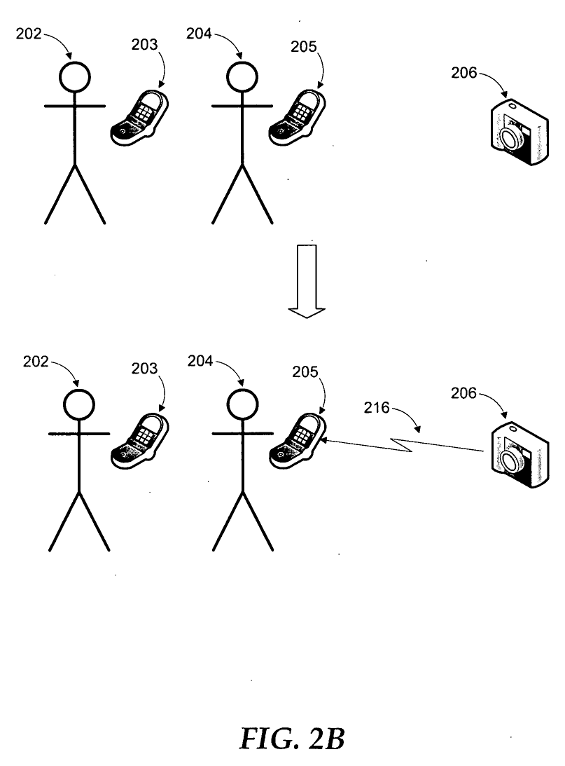

In FIG. 2A, scenarios displaying access to an image associated with identifiers of nearby devices is illustrated. Digital camera 206 may query and receive identifiers of nearby devices with short range transceivers (203 and 205) carried by users 202 and 204. This communication may take place before or after capturing an image of users 202 and 204. The received identifiers may be associated with the captured image by maintaining a table or database of image files and corresponding device identifiers, inserting the identifiers into the captured image files (which is referred to herein as tagging the image file), inserting the identifiers into captured image file metadata, or similar methods. Captured images associated with nearby device information in camera 206 may be uploaded to a personal computer 208 or similar computing devices.

According to some embodiments, computer 208 may execute an image processing application that determines a user profile id associated with the short range transmitter identifier to further tag a user profile id into the metadata. Computer 208 may then upload the images to server 210. Uploaded images may be accessed by user 202 (or any other user) using information associated with the nearby device identifier to receive access to uploaded picture. The user may access the server 210 through network(s) 212.

According to embodiments, devices 203 and 205 may be a cell phone, a personal digital assistant (PDA) device, a laptop, a digital music player, a Radio Frequency Identification (RFID) chip, and similar devices with short range transceivers.

In FIG. 2B, scenarios whereby digital camera notifies nearby devices of tagging the images with device identifier is illustrated. Digital camera 206 may query and receive nearby device's short range transceiver identifier from devices 203 and 205 carried by users 202 and 204. Upon receiving the identifiers and tagging captured images (or their metadata), camera 206 may notify 216 device 204 of availability of tagged images.

According to other embodiments, a nearby device (e.g. 203) that has received a notification from the digital camera 206 may alert user (e.g. 202) to the availability of images for download. In subsequent access to the server storing the tagged images, the user may use the nearby device as a key in authenticating to the server and receive access to the images having nearby device tag for display, printing, download and other purposes. According to further embodiments, digital camera 206 may offer to transmit the captured image directly to one of the nearby devices (203, 205).

While the example systems in FIGS. 2A and 2B have been described with specific components such as a cell phone, a digital camera, and similar devices, embodiments are not limited to these components or system configurations and can be implemented with other system configuration employing fewer or additional components. Functionality of systems enabling tagging of captured images with short range transceiver identifiers may also be distributed among the components of the systems differently depending on component capabilities and system configurations.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

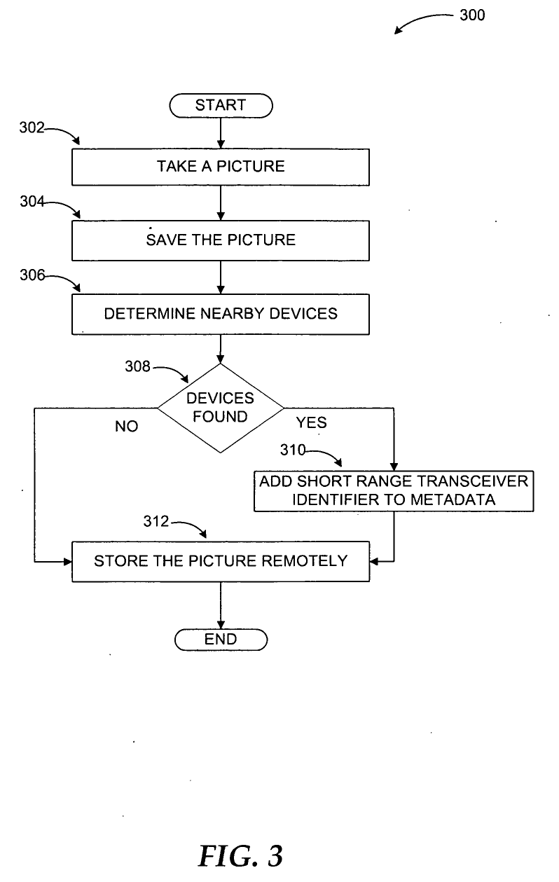

FIG. 3 illustrates a logic flow diagram 300 for tagging a captured picture with short range transmitter tag. As discussed above, tagging a captured picture with nearby device information is one example implementation of embodiments. Other examples may include associating video images, audio recordings, and similar data with nearby device information in form of database association, tagging the data itself, or tagging the metadata associated with the image/audio recording data. Process 300 may be implemented as part of image processing and access application such as the one described above in conjunction with FIGS. 2A and 2B.

Process 300 begins with operation 302, where a user takes a picture with a digital camera. At subsequent operation 304, the digital camera saves the picture. Following the saving operation, the digital camera determines availability of nearby devices via querying nearby devices using camera's short range transceiver. Alternatively, the determination may occur prior to capturing of the image (i.e. the camera may preemptively search for nearby devices, then associate them with the image when it is captured).

At operation 308, upon finding nearby devices, the digital camera adds found device's short range transceiver identifier into the metadata of the picture in subsequent operation 310. In operation 312, the tagged picture may be stored remotely in a personal computer or a networked system.

If no nearby devices are found at operation 308, the picture may be stored remotely without the identifier information.

The operations included in process 300 are for illustration purposes. Tagging the short range transceiver identifier of a nearby device into a picture's metadata and remote storage may be implemented by similar processes with fewer or additional steps, as well as in different order of operations using the principles described herein. For example, the nearby devices may be detected before the picture is taken or captured pictures may be offered for transmission to the detected nearby devices.

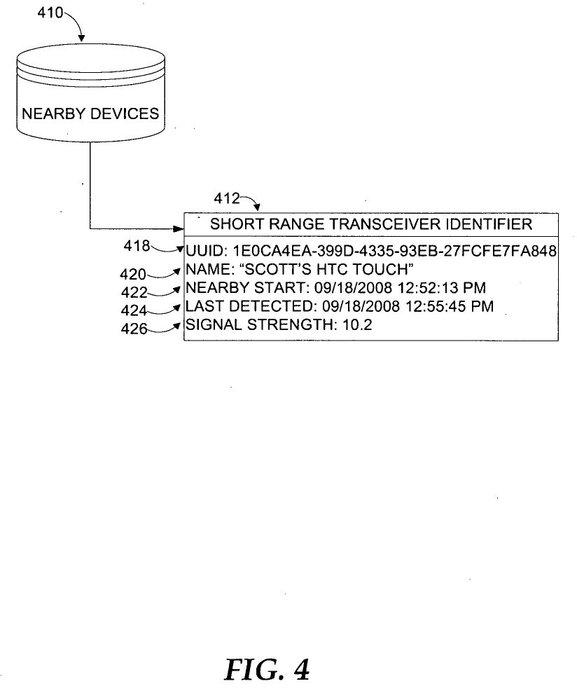

FIG. 4 illustrates short range transceiver identifiers transmitted by nearby devices 410 and used by the digital camera to tag the picture file 412. Unique User ID 418 corresponds to identifier number assigned to the nearby device. Name 418 corresponds to a descriptive term given to the nearby device. Nearby start 422 is a date/time stamp indicating when the digital camera first detects the nearby device. Last detected 424 is a date/time stamp indicating when the camera last received a proximity notification from the nearby device. According to some embodiments, the last detected information may be used automatically exclude tags detected outside of duration of time specified by the user. And, the signal strength 426 indicates the power of the available signal from the nearby device. According to some embodiments, the signal strength information may be used to determine location or inclusion of people in the captured image and further used in processing, providing access to the captured image, and comparable actions.

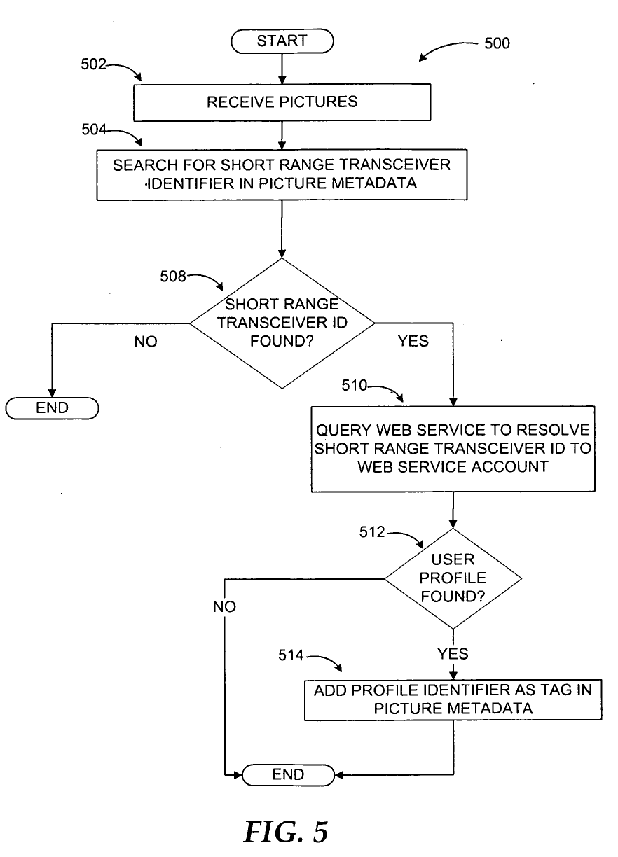

FIG. 5 illustrates a logic flow diagram 500 for further tagging the picture with user account id by utilizing the short range transceiver identifier. Process 500 may be implemented as part of image processing during picture upload to a web service such as the one described above in conjunction with FIG. 2A.

Process 500 begins with operation 502, where a personal computer receives a picture from the digital camera. At subsequent operation 504 a photo application running on the personal computer performs a search for a short range transceiver identifier embedded in the picture's metadata. If at process 508 no short range transceiver identifiers are found, then the photo application may end user profile identifier tagging, and may upload the picture into a server for later access.

Upon finding a short range transceiver identifier in process 508, the photo application queries a web service to resolve short range transceiver's unique user identifier number matching the nearby device to a user profile identifier. If at process 512 a matching user profile identifier is found, then at process 514 the photo application adds a profile identifier tag into the picture's metadata for the corresponding short range transceiver identifier and uploads the picture into the server for later access. If no matching user profile identifier may be found at process 512, the photo application may upload the picture into the server for later access.

In some embodiments, the short range transceiver identifier may be a Bluetooth tag (UUID), a wireless USB HID tag, and others. The user profile identifier may be a .NET Passport® or a Windows Live ID® by MICROSOFT CORP. of Redmond, Wash., and others such as commonly used social networking websites. Embodiments described here are not limited to specific examples provided.

The operations included in process 500 are for illustration purposes. Tagging profile information into the picture's metadata and remote storage may be implemented by similar processes with fewer or additional steps, as well as in different order of operations using the principles described herein.

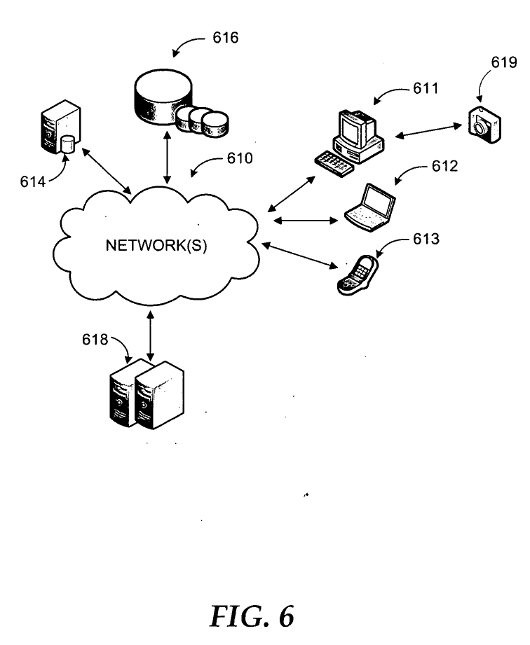

FIG. 6 is an example networked environment, where embodiments may be implemented. A platform providing access to tagged pictures may be implemented via software executed over one or more servers 618 such as a hosted service. The platform may communicate with consuming applications on individual computing devices such as a cellular phone 613, a laptop computer 612, and desktop computer 611 through network(s) 610.

As discussed previously, computing devices 611-613 are used to facilitate communications through a variety of modes between subscribers to tagged picture service. Information associated with user profiles and facilitating communications may be stored in one or more data stores (e.g. data store 616), which may be managed by any one of the servers 618 or by database server 614.

Network(s) 610 may comprise any topology of servers, clients, Internet service providers, and communication media. A system according to embodiments may have a static or dynamic topology. Network(s) 610 may include a secure network such as an enterprise network, an unsecure network such as a wireless open network, or the Internet. Network(s) 610 may also comprise a plurality of distinct networks such as Unified Communications network, PSTN, and cellular network. Network(s) 610 provides communication between the nodes described herein. By way of example, and not limitation, network(s) 610 may include wireless media such as acoustic, RF, infrared and other wireless media.

Many other configurations of computing devices, applications, data sources, and data distribution systems may be employed to implement a system for providing access to captured images based on associating nearby device identifiers with the captured image data. Furthermore, the networked environments discussed in FIG. 6 are for illustration purposes only. Embodiments are not limited to the example applications, modules, or processes.

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as digital camera 700. In a basic configuration, digital camera 700 may include at least one processing unit 702 and system memory 704. Digital camera 700 may also include a plurality of processing units that cooperate in executing programs. Depending on the exact configuration and type of digital camera, the system memory 704 may be volatile (such as RAM), non-volatile (such as ROM, flash memory, etc.) or some combination of the two. System memory 704 typically includes an operating system 705 suitable for controlling the operation of the platform, such as a firmware. The system memory 704 may also include one or more software applications such as program modules 706, image processing application 722, and notification module 724.

Image processing application 722 and notification module 724 may be separate applications or integral modules of a hosted service that provides image access services to client applications/devices. Notification module 724 may notify nearby devices of tagged pictures.

Digital camera 700 may have additional features or functionality. For example, the digital camera 700 may also include additional data storage devices (removable and/or non-removable) such as, for example, magnetic disks, or optical disks. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, magnetic disk storage or other magnetic storage devices, or any other medium which can be used to store the desired information and which can be accessed by digital camera 700. Any such computer readable storage media may be part of digital camera 700. Digital camera 700 may also have input device(s) 712 such as keypad, mouse, pen, voice input device, touch input device, and comparable input devices. Output device(s) 714 such as a display, speakers, printer, and other types of output devices may also be included. These devices are well known in the art and need not be discussed at length here.

Digital camera 700 may also contain communication connections 716 that allow the device to communicate with other devices 718, such as over a wireless network in a distributed computing environment, a cellular link, and comparable mechanisms. Other devices 718 may include computer device(s) that execute image processing services, access management services, and comparable ones. Communication connection(s) 716 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in an image capture device for managing access to captured images, the method comprising:
capturing an image of a plurality of people with the image capture device;
determining at least one nearby short range communication device associated with at least one of the plurality of people;
associating the captured image with an identifier of the at least one short range communication device; and
storing the captured image such that access to the image is provided at least based on the associated identifier of the at least one short range communication device.

2. The method of claim 1, wherein the at least one nearby short range communication device is one from a set of: a cell phone, a Personal Digital Assistant (PDA), a notebook, a digital camera, a Radio Frequency Identification (RFID) chip containing device, and a digital music player.

3. The method of claim 1, wherein the short range communication is performed through employing one of a Bluetooth protocol, and a wireless Universal Serial Bus (USB) Human Interface Device (HID).

4. The method of claim 1, wherein the short range communication device identifier comprises at least one from a set of:
a unique user id number;
a device name;
a device nearby start date/time stamp;
a device last detected date/time stamp; and
a device signal strength.

5. The method of claim 1, the captured image is associated with the identifier of the at least one short range communication device by one of: maintaining a table of captured images and associated short range communication device identifiers, maintaining a table of captured images and associated short range communication device identifiers, inserting the short range communication device identifier into the captured image data, and inserting the short range communication device identifier into the captured image metadata.

6. The method of claim 1, wherein the captured image is stored remotely by uploading the captured image to a computing device.

7. The method of claim 6, further comprising:
receiving the captured image at the computing device;
parsing the short range communication device identifier;
querying a web service to resolve a unique user identifier based on the parsed short range communication device identifier; and
associating the captured image with the unique user identifier.

8. The method of claim 7, further comprising:
making the captured image available for downloading at the web service, wherein access to the captured image is controlled based on the unique user identifier.

9. The method of claim 1, wherein the identifier is used to identify people in a recorded image.

10. The method of claim 1, wherein the captured image is one of a still image and a video recording.

11. The method of claim 1, further comprising:
notifying the plurality of people about availability of the captured image through short range communication from the image capturing device to the nearby short range communication devices.

12. A system for utilizing nearby device detection to provide access to recordings, the system comprising:
a recording device configured to:
detect nearby devices with short range communication capability;
receive identifiers of detected nearby devices with short range communication capability;
capture a recording;
associate the captured recording with the received identifiers;
a networked computing device configured to:
receive the captured recording and associated nearby device identifiers;
query a web service to resolve unique user profiles identifier associated with the nearby device identifiers; and
render the recording available to users associated with the resolved unique user profiles.

13. The system of claim 12 wherein the recording includes one of: a still image, a video recording, a whiteboard capture, and an audio recording.

14. The system of claim 12, wherein the recording device is further configured to:
notify the detected nearby devices about the availability of the captured recording through short range communications.

15. The system of claim 14, wherein the recording device is further configured to:
transmit the captured recording to the detected nearby devices upon receiving a request from the detected nearby devices.

16. The system of claim 12, wherein the recording device is further configured to:
associate select ones of the detected nearby devices with the captured recording based on a signal strength of short range communications with each nearby device.

17. A computer-readable storage medium having instructions stored thereon for utilizing nearby device detection to provide access to a captured picture, the instructions comprising:
enabling capture of a picture with a digital camera;
saving the picture at the camera;
determining at least one available nearby device capable of short range communication;
tagging the picture with identifiers of detected nearby devices;
transmitting the captured picture to a web service;
associating the picture with a user profile based on the detected device identifiers at the web service;
notifying a user associated with the user profile about the availability of the picture; and
enabling access to the picture for the user by authenticating the user based on the user profile.

18. The computer-readable medium of claim 17, wherein tagging the picture includes one of: associating the picture with a detected nearby device identifier, inserting the detected nearby device identifier to captured picture data, and inserting the detected nearby device identifier to captured picture metadata.

19. The computer-readable medium of claim 17, wherein access to the picture includes at least one from a set of: enabling the user to download the picture, enabling the user to print the picture, enabling the user to forward the picture to another user, and enabling the user to edit the picture.

20. The computer-readable medium of claim 17, wherein the instructions further comprise:
transmitting an authentication key to the detected nearby devices for use in authenticating a user associated with a detected nearby device to the web service for accessing the picture.
